(19) United States
(12) Patent Application Publication
(10) Pub. No.: US 2005/0130614 A1
(43) Pub. Date: Jun. 16, 2005

(54) Function calling apparatus and computer program for executing a function calling process

(75) Inventor: Katsumi Suzuki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 11/002,824

(22) Filed: Dec. 2, 2004

(30) Foreign Application Priority Data
Dec. 11, 2003 (JP) 2003-413011

(51) Int. Cl. H04B 1/18

(52) U.S. Cl. 455/186.2

(57) ABSTRACT

When a function designated by operation of a function setting switch has been executed, a shortcut icon of instructing to start up the function is automatically registered to a stand-by screen. When a user operates the shortcut icon registered to the stand-by screen, the function assigned to the shortcut icon starts up, whereby even if the user operates a wrong operation key and calls out an undesired function, the function that has been executed just before can be called out instantly and in a simple manner.

### BACKGROUND OF THE INVENTION

1. Field of the Invention

The present invention relates to a function calling apparatus and a computer program for executing a function calling process, which are preferably used in cellular phones, PDAs and the like.

2. Description of the Related Art

Many handheld terminals such as cellular phones, PDA and the like are provided with a function calling device, which is employed to provide users with improved convenience and allows the user to select a desired function (application program) from among plural hierarchized functions and to start up the selected function with minimum number of key operations. For instance, a cellular phone equipped with this sort of device is disclosed in Japanese laid-open patent application No. 2003-101629. In the technology disclosed therein, a pointer is registered as a shortcut for an application program which has been set to run and used frequently, and when a software key is operated twice in a certain period of time, the application program whose shortcut is registered is set to run.

Though the technology disclosed in Japanese laid-open patent application No. 2003-101629 may be used conveniently to start up the function that is used frequently, it has a drawback such that, when the user has operated a wrong key and has called his or her undesired function, the user is required to operate keys many times so as to follow hierarchized functions from the very first to return to the function that he or she has used just before. In the technology described, it is hard to call out instantly and in a simple manner the function that has been used just before.

### SUMMARY OF THE INVENTION

The present invention has been made in consideration of the situations mentioned above and has an object to provide an apparatus which can call out simply and instantly the function that has been used just before.

The apparatus of the present invention is characterized in that when execution of a designated function has been completed, a shortcut icon of instructing to set the function to run is registered on a screen, and when a user operates the registered shortcut icon, the function assigned to the shortcut icon is instructed to start up.

The apparatus of the present invention is characterized in that when a designated function is executed, a shortcut icon of instructing to set the function to run is registered on a screen, and when the user operates the registered shortcut icon after execution of the designated function has been completed, the function assigned to the shortcut icon is instructed to start up.

The apparatus of the present invention is characterized in that when execution of a designated function has been completed, a shortcut icon of instructing to set the function to run is registered at a position easy to select first at all times on a screen, and when a user operates the registered shortcut icon, the function assigned to the shortcut icon is instructed to start up.

With the configuration described above, even if the user operate a wrong key and called out his or her undesired function, the function that has been used just before can be called out instantly and simply.

### BRIEF DESCRIPTION OF THE DRAWINGS

FIG. 1 is a block diagram showing a circuit configuration of an embodiment of the present invention.

FIG. 2 is a flow chart of a main routine process.

FIG. 3 is a flow chart of a main routine process.

FIG. 4 is a flow chart of a main routine process.

FIG. 5 is a flow chart of a stand-by screen displaying process.

FIG. 5 is a flow chart of a stand-by screen displaying process.

FIG. 6 is a flow chart of a shortcut adding/removing process.

FIG. 7 is a flow chart of an icon adding process.

FIG. 8 is a flow chart of an icon removing process.

FIG. 9 is a flow chart of a shortcut registering process.

### DETAILED DESCRIPTION OF THE PREFERRED EMBODIMENTS

Now, an embodiment of a cellular phone provided with a function calling function according to the present invention will be described with reference to the accompanying drawings.

A. Configuration

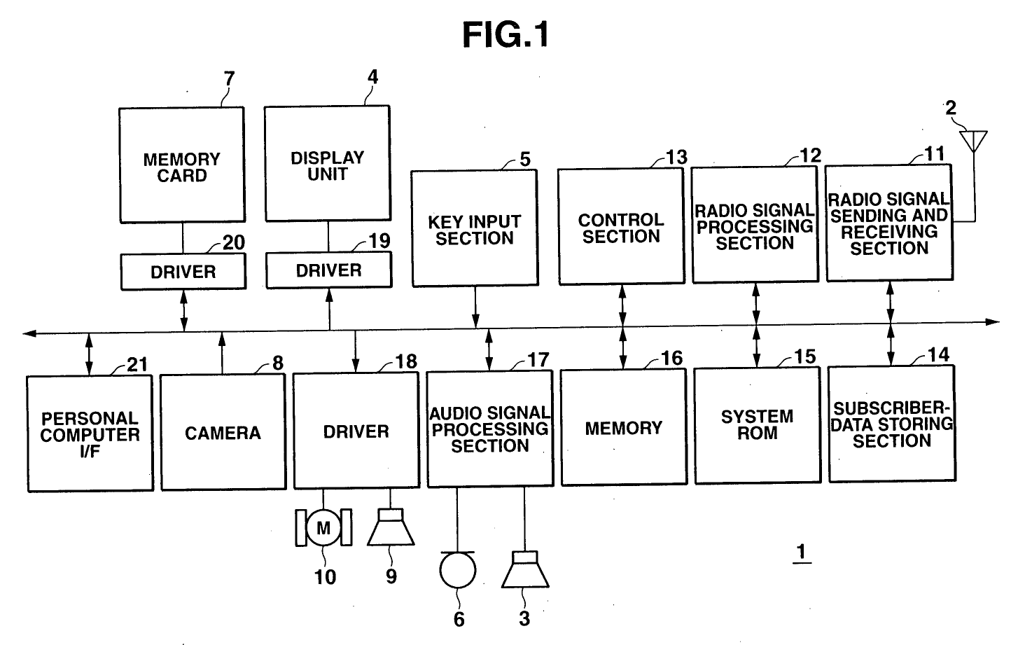

FIG. 1 is a block diagram showing a circuit configuration of a cellular phone 1 according to an embodiment of the present invention. A mechanical structure thereof will be described first. The cellular phone 1 has a body structure of a flip-phone type. The body case (not shown) is provided with a signal sending/receiving antenna 2, a voice speaker 3, a display unit 4 including a color liquid crystal display panel, a key input section 5, a microphone 6 for entering voices, a detachable data-storing medium 7 such as a re-writable memory card, into which data is written and/or from which data is read out, a camera 8 for picking up an image, a speaker for notifying an incoming call, and a vibrator 10 for notifying an incoming call. Further, the body case has a switch (not shown) for detecting an open state of the cellular phone and a closed state thereof and for turning off a back light of the display unit 4 when the cellular phone is in the closed state and for turning on the back light when the cellular phone is in the open state.

The key input section 5 includes various switches, such as a power switch, an off-hook/on-hook switch which is operated at dialing or communicating or at breaking line, switches both for dialing and for entering characters, a function setting switch for selecting various functions including a “shortcut adding function” and a “shortcut removing function”, a clear switch for removing displayed contents, a cursor switch for selecting an item, and decision switch for setting the item selected by the cursor switch.

An electric configuration of the cellular phone 1 will be described. A radio signal sending/receiving section 11 amplifies a high frequency signal received through the antenna 2 and supplies the same to the next stage, that is, a radio signal processing section 12. Meanwhile, the radio signal sending/receiving section 11 amplifies a high frequency signal output from the radio signal processing section 12 and transmits the same through the antenna 2. The radio signal processing section 12 demodulates the high frequency signal amplified by the radio signal sending/receiving section 11, and also modulates transmitting data supplied from a control section 13 to generate a transmitting signal. The control section 13 receives and/or sends commands and data through a system bus to control the whole apparatus. Operation of the control section 13, which relates to the essence of the present invention, will be described in detail later.

A subscriber-data storing section 14 has an address area, an incoming-call record area, and an outgoing-call record area. A system ROM 15 stores programs to be executed by the control section 13 to control communication processes, and various control data, such as an icon table ITBL including a table of icon identifiers for identifying shortcut-icon image data corresponding to function names.

It should be noted that the programs for controlling communication processes includes a main routine program as will be described. The main routine process includes a stand-by screen displaying process, a shortcut adding/removing process, and a shortcut registering process. The shortcut setting/removing process includes an icon adding process and an icon removing process.

A memory 16 has a work area, a data area, a mail area and a user area. The work area of the memory 16 temporarily stores register-flag data used by the control section 13 to execute various functions. The data area of the memory 16 stores image data for various screens, including background screen data for the stand-by screen, and icon-image data for shortcut functions. The mail area of the memory 16 has an area for writing a mail, a pick-up mail box for storing received mails and a sending-mail box for storing sent mails. The user area of the memory 16 stores image data picked up by the camera 8, and melody data downloaded via the communication network for notifying an incoming mail.

An audio signal processing section 17 converts digital data, such as voice data of telephone conversation and synthesized voice data, into an analog signal to output sounds through the speaker 3, and also converts an analog audio signal output from the microphone 6 into digital audio data and supplies the same to the control section 13. A driver 18 drives LED 81 of the camera 8, the speaker 9 and the vibrator 10 to notify an incoming call. A driver 20 reads and/or writes data from or into the memory card 7 under control of the control section 13. The memory card 7 has storage capacity for storing various data including image data picked up by the camera 8, image data input from an external apparatus, and music data. A personal computer interface 21 comprises a serial interface such as USB cable.

B. Operation

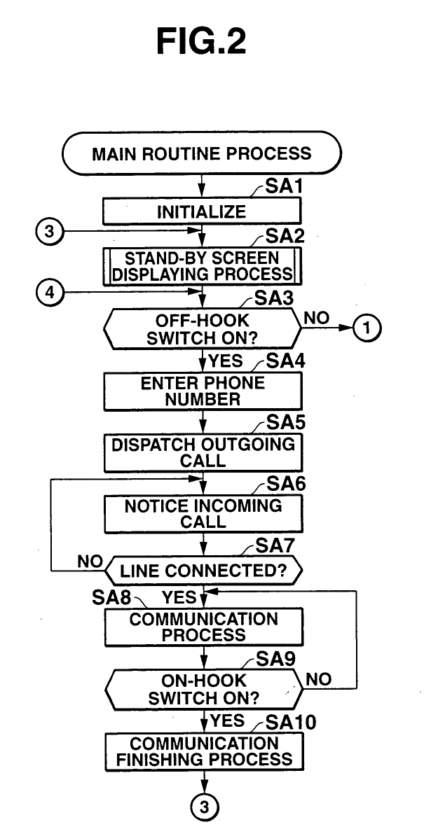

Now, operation of the function-calling apparatus provided on the cellular phone 1 having the above mentioned configuration will be described. With reference to FIG. 2 through FIG. 9 will be described operation of the control section 13 of the cellular phone 1 for executing processes such as the main routine process, a stand-by screen producing process, a shortcut adding/removing process, an icon adding process, and an icon removing process.

(1) Main Routine Process

When the power switch of the cellular phone 1 is turned on, the control section 13 executes the main routine process shown in FIG. 2 through FIG. 4. At step SA1 in FIG. 2, the control section 13 initializes every section of the cellular phone 1. Having finished the initializing process, the control section 13 executes a stand-by screen displaying process at step SA2. In the stand-by screen displaying process, shortcut icon images corresponding to functions for which shortcuts are registered respectively are arranged and displayed in place on a stand-by back-ground screen. The shortcut image which is disposed at the leading position on the stand-by back-ground screen is highlighted on the display unit 4.

At step SA3 and thereafter, processes corresponding to operations of the switches (the off-hook switch, on-hook switch, function setting switch, cursor switch and decision switch) are executed. These processes will be described hereafter.

(a) In case that the off-hook switch is operated:

When a user operates the off-hook switch (YES at step SA3), the operation proceeds to step SA4, where the stand-by screen displayed on the display unit 4 is switched to a phone-number entering screen, and the phone number which the user enters using the enter keys is displayed on the phone number entering screen. When the phone number has been entered, an outgoing call is dispatched to make a call. When the receiving party takes off the hook in response to the notice of an incoming call, the phone line is connected (YES at step SA7), and the operation proceeds to step SA8, where the communication process is executed.

(b) In case that the on-hook switch is operated:

Now, it is assumed that the user places the hook (YES at step SA9) in the middle of the communication process at step SA8. Then, the operation proceeds to step SA10, where a communication finishing process is executed to break the phone line. Thereafter, the operation returns to the process at step SA2, where the stand-by screen is displayed again.

(c) In case that the function setting switch is turned on:

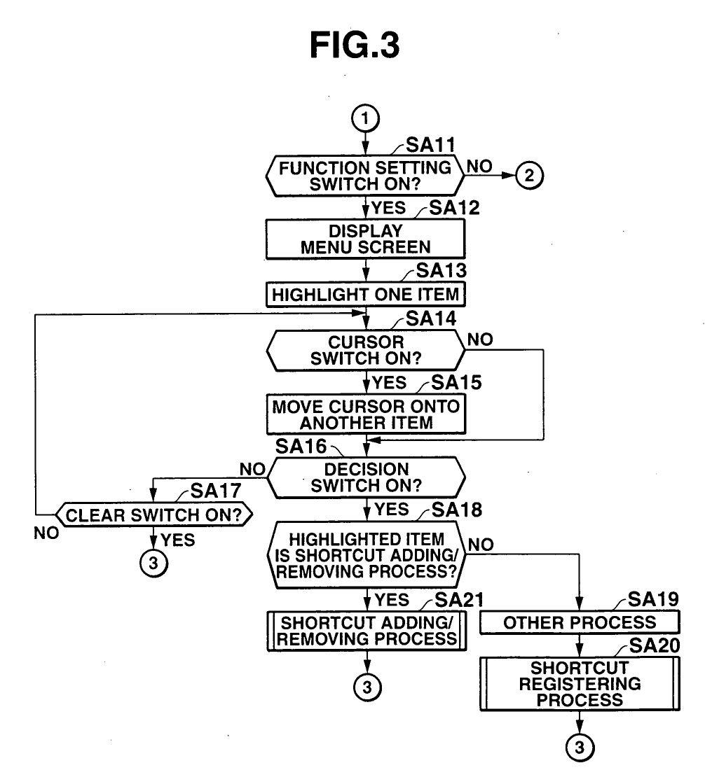

When the function setting switch is turned on with the stand-by screen displayed (YES at step SA11 in FIG. 3), the operation proceeds to step SA12, where a menu screen (not shown) is displayed on the display unit 4. The menu screen includes a list of item icons representing various functions such as a camera function and a mail function. One (default item) of the item icons displayed on the menu screen is selected and highlighted by moving the cursor onto the same item icon at step SA13.

At step SA14, it is judged whether or not the cursor switch is operated. When the cursor switch is operated (YES at step SA14), the cursor is moved onto another item icon to highlight the same at step SA15, and then the operation proceeds to step SA16. When the cursor switch is not operated (NO at step SA14), and then the operation proceeds to step SA16. At step SA16 and thereafter, it is judged whether or not the decision switch and/or the clear switch are operated. When neither the decision switch nor the clear switch is operated (NO at steps SA16 and SA17), the operation returns to the process at step SA14. When the clear switch is operated (YES at step SA17), the operation returns to the process at step SA2 in FIG. 2, where the stand-by screen is displayed.

Meanwhile, when the decision switch is operated (YES at SA16), the operation advances to step SA18, where it is judged whether the item icon that is highlighted when the decision switch is operated represents the item of “shortcut adding/removing process” or not. When the highlighted item icon represents a process other than the “shortcut adding/removing process” (NO at step SA18), the operation advances to step SA19, where the process other than the “shortcut adding/removing process”, corresponding to the highlighted item icon is executed. At step SA20, a shortcut registering process to be described later is executed to register a shortcut for the function that has been performed at the previous step SA19. Then, the operation returns to step SA2 (FIG. 2), where the stand-by screen is displayed again. When the item icon representing the “shortcut adding/removing process” is highlighted at the time when the decision switch is operated (YES at step SA18), the operation advances to step SA21, where the “shortcut adding/removing process” is executed as will be described later, and then the operation returns to step SA2, where the stand-by screen is displayed again.

(d) In case that the cursor switch is turned on:

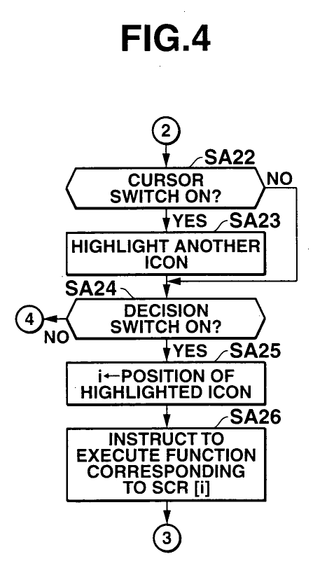

When the cursor switch is turned on with the stand-by screen displayed on the display unit 4 (YES at step SA22 in FIG. 4), the operation advances to step SA23, where the cursor is moved to another shortcut icon to highlight the same on the stand-by screen.

(e) In case that the decision switch is turned on:

When the user turns on the decision switch with the stand-by screen displayed (YES at step SA24), the operation advances to step SA25, where a value representing a position of a shortcut icon that is highlighted at the time when the decision switch is operated is stored in a register i. At step SA26, the control section 13 instructs to perform a process for executing the function that is specified by shortcut registering data stored in a shortcut register SCR[i] designated by the value stored in the register i. In other words, the function starts up, which is represented by the shortcut icon highlighted at the time when the decision switch is operated. The shortcut registering data stored in the shortcut register SCR[i] includes a function name, a shortcut of which is registered, and a program point for designating the process program corresponding to the function name.

(2) Operation of a stand-by screen displaying process:

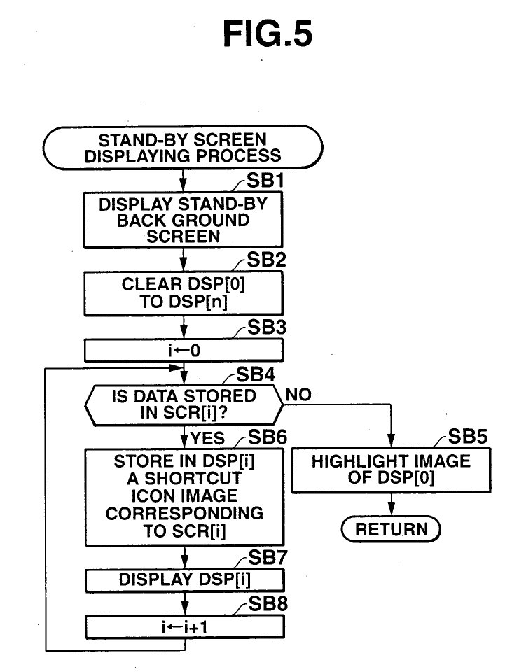

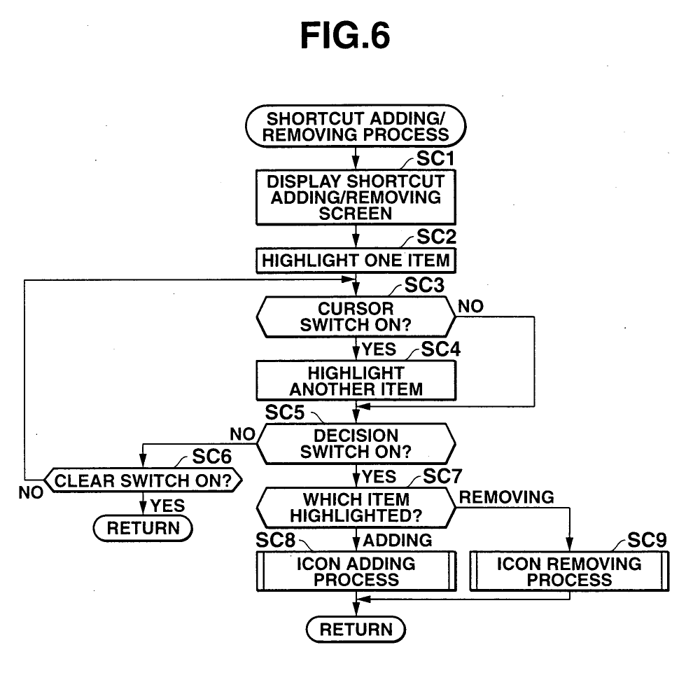

Now, operation of the stand-by screen displaying process will be described with reference to the flow chart of FIG. 5. When the process of step SA2 in the main routine process of FIG. 2 has been executed, the control section 13 advances to step SB1 shown in FIG. 5, where the control section 13 reads out back-ground image data for the stand-by screen from the data area on the memory 16 to display the stand-by back ground screen on the display unit 4. At step SB2, registers DSP[0] to DSP[n] for storing shortcut icon image data are cleared. At step SB3, a search pointer i is reset to “0”. Then, it is judged at step SB4 whether or not shortcut registering data is stored in the shortcut register SCR[i] designated by the pointer i.

When registered data is stored in the shortcut register SCR[i] (YES at step SB4), the operation proceeds to step SB6, where shortcut icon image data corresponding to the shortcut registering data stored in the shortcut register SCR[i] is stored in the register DSP[i]. More specifically, icon identifier of the shortcut icon image data corresponding to the function name included in the shortcut registering data is read out with reference to an icon table ITBL stored in the system ROM 15, and further shortcut icon image data designated by the icon identifier is read out from the data area of the memory 16 and is stored in the register DSP[i]. At step BS7, the shortcut icon image data stored in the register DSP[i] is displayed on the stand-by back ground screen. Positions on the stand-by background screen where the shortcut icon image data stored in the registers DSP[0] to DSP[n] are displayed respectively are previously set.

At step SB8, the search pointer i is incremented, and the operation returns to step SB4, where the processes at step SB4 through SB8 are repeatedly executed until all the shortcut registering data have been read out from the shortcut register SCR[i], whereby the shortcut icon image corresponding to function name, shortcut for which is registered, is disposed in place and displayed on the stand-by background screen. When all the shortcut registering data have been read out from the shortcut register SCR[i] (NO at step SB4), the operation advances to step SB5, where all the shortcut icon images are arranged and displayed on the stand-by back ground screen and the shortcut icon image located at the leading location is highlighted.

In the stand-by screen displaying process described above, the shortcut icon images corresponding to the function names, the shortcuts of which are registered, are disposed in place and displayed on the stand-by screen, and the shortcut icon image located at the leading location is highlighted.

(3) Operation of the shortcut adding/removing process:

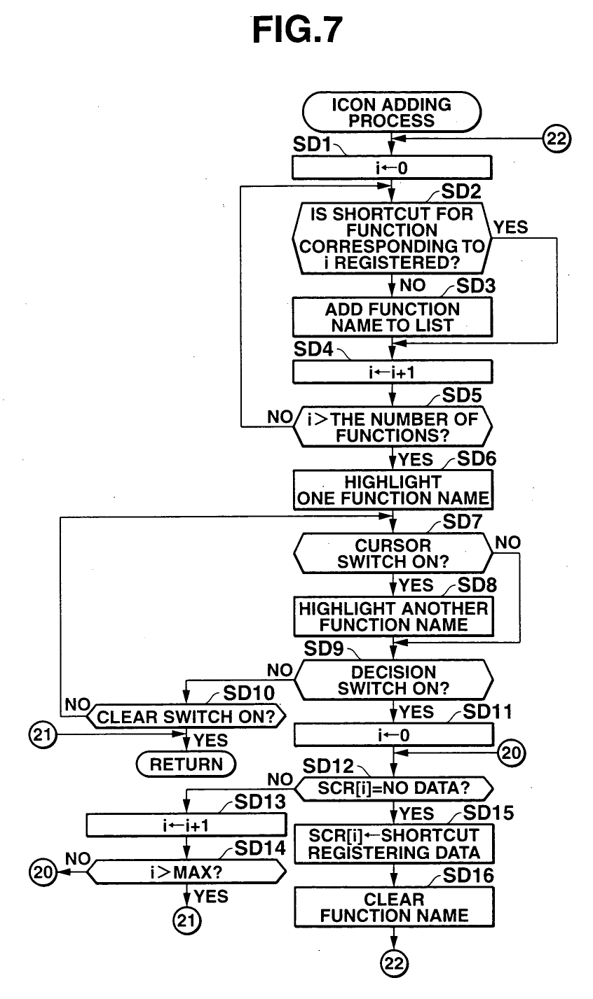

Operation of the shortcut adding/removing process will be described with reference to the flow chart shown in FIG. 6. When the process of step SA21 in the main routine process shown in FIG. 3 has been executed, the control section 13 advances to step SC1 shown in FIG. 6, where a shortcut adding/removing screen is displayed on the display unit 4. The shortcut adding/removing screen includes items of “add” and “remove” (not shown) to be highlighted. At step SC2, either “add” or “remove” is highlighted. For example, if the item of “add” is a default item, then the item of “add” is highlighted. Processes at step SC3 through step SC9 are executed in response to operation of the cursor switch, the decision switch, and the clear switch.

More specifically, when the cursor switch is operated (YES at step SC3), the operation advances to step SC4, where the cursor is moved to another item. When the decision switch is operated (YES at step SC5), the operation advances to step SC7, where it is judged whether the cursor stays on the item of “add” or the item of “remove” when the decision switch has been operated. When the cursor stays on the item of “add”, the operation advances to step SC8, where an icon adding process (as will be described later) is executed to add a shortcut icon to the stand-by screen. Meanwhile, when the cursor stays on the item of “remove”, the operation advances to step SC9, where an icon removing process (as will be described later) is executed to remove a shortcut icon from the stand-by screen. When the clear switch is operated to cease the present process (YES at step SC6), no process is executed and the present process is finished.

(4) Operation of the icon adding process:

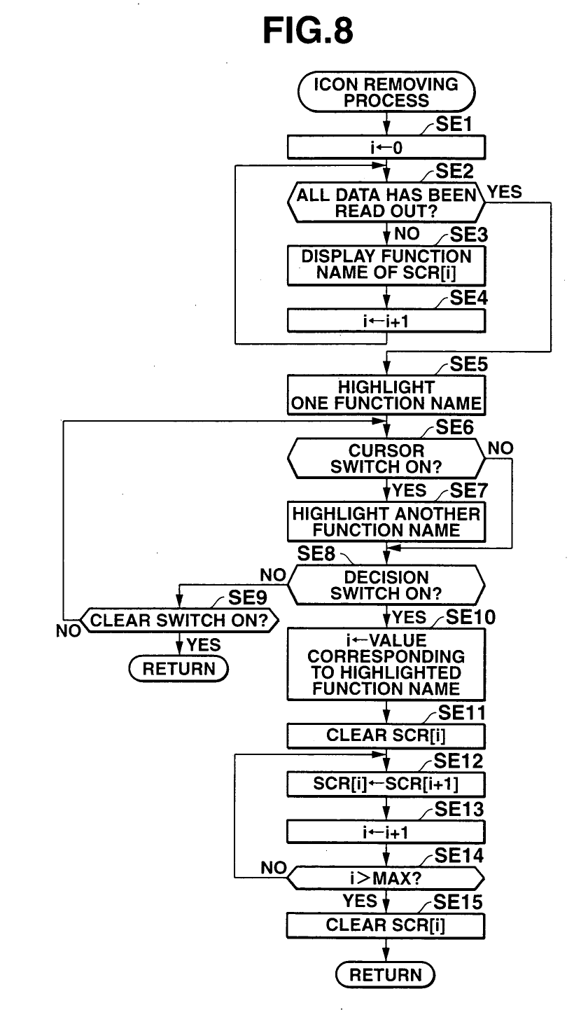

Now, operation of the icon adding process will be described with reference to the flow char shown in FIG. 7. When the icon adding process of step SC8 (FIG. 6) is executed, the control section 13 advances to step SD1 shown in FIG. 7, where the search pointer i is reset to “0”. In the processes at step SD2 through step SD5, an icon adding screen (not shown) is produced and displayed on the display unit 4 to display a list of function names, shortcuts for which have not been registered. More specifically, it is judged at step SD2 whether a shortcut for a function corresponding to the search pointer i has been registered or not. When the shortcut has been registered (YES at step SD2), the operation advances to step SD4.

When the shortcut has not been registered (NO at step SD2), the operation advances to step SD3, where the function name, the shortcut for which has not been registered, is added to the function name list. At step SD4, the search pointer i is incremented, and at the following step SD5, it is judged whether or not the incremented search pointer i exceeds the number of the functions, that is, it is judged whether all the function names whose shortcuts have not been registered, have been searched for or not. When all the function names, shortcuts for which were not registered, have not been searched for (NO at step SD5), the operation returns to step SD2, and thereafter the processes at step SD2 through step SD5 are repeatedly executed until all the function names, shortcuts for which were not registered, have been searched for.

When the icon adding screen has been produced for displaying a list of function names whose shortcuts have not been registered, the control section 13 advances to a process at step SD6, where one function name among the list of function names is highlighted. At step SD7 through step SD10, processes corresponding to operation of the cursor switch, the decision switch, and the clear switch are executed. When the clear switch is operated (YES at step SD10), the present process is finished. Meanwhile, when the cursor switch is operated (YES at step SD7), the operation proceeds to step SD8, where the cursor is moved to another item. When the decision switch is operated (YES at step SD9), the operation proceeds to step SD11.

At step SD11 through step SD15, while the search pointer i is incremented up to as much as the maximum number of the icons that can be registered, an empty shortcut register SCR[i] is searched for and in the empty shortcut register SCR[i] is stored shortcut registering data, including a function name designated on the icon adding screen and a program pointer designating a process program corresponding to the function name.

In other words, the searcher pointer i is reset to “0” at step SD11, and at the following step SD12 it is judged whether the shortcut register SCR[i] corresponding to the search pointer i is an empty register or not. If the shortcut register SCR[i] is not an empty register (NO at step SD12), then the operation advances to step SD 13, where the search pointer i is incremented.

Then, it is judged at step SD14 whether or not the incremented search pointer i exceeds the maximum number of the icons that can be registered. When the incremented search pointer i exceeds the maximum number of the icons (YES at step SD14), the present process is finished. But if the incremented search pointer i has not yet exceeded the maximum number of the icons (NO at step SD14), the operation returns to SD12. Thereafter, the processes at step SD12 through step SD14 are repeatedly executed to search for an empty shortcut register SCR[i] until the search pointer i exceeds the maximum number of the icons. When an empty shortcut register SCR[i] has been found (YES at step SD12), the operation advances to step SD15, where in the empty shortcut register SCR[i] is stored shortcut registering data, including a function name designated on the icon adding screen and a program pointer designating a process program corresponding to the function name. Then, the operation proceeds to step SD16, where the registered function name is removed form the function name list on the icon adding screen, and the operation returns to step SD1.

In the icon adding process described above, when a function name, the shortcut for which the user wants to register, is selected from among the list of function names on the icon adding screen, shortcuts for which have not yet been registered, the shortcut registering data including the function name and the program pointer designating a process program corresponding to the function name is registered in the empty shortcut register SCR[i]. In the stand-by screen displaying process described above (FIG. 5), when a new shortcut registering data is registered in the shortcut register SCR[i], the stand-by screen including the shortcut icon image registered in the register DSP[i] is displayed.

(5) Operation of the icon removing process:

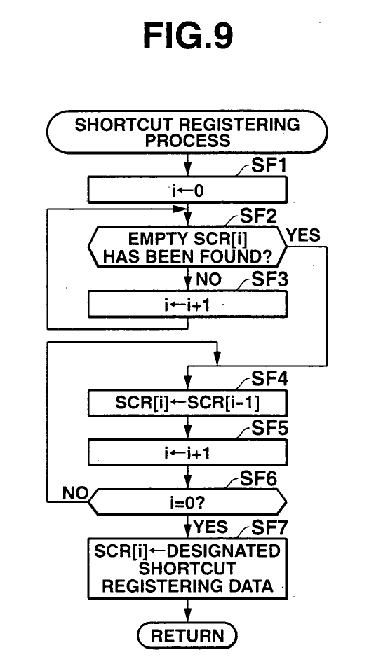

Operation of the icon removing process will be described with reference to the flow chart of FIG. 8. When the icon removing process of step SC9 (FIG. 6) is executed, the control section 13 advances to step SE1 shown in FIG. 8, where the search pointer i is reset to “0”. In processes at step SE2 through step SE4, all the shortcut registering data is read out from the shortcut register SCR[i] to create and display on the display unit 4 the icon removing screen (not shown) including the list of function names, the shortcuts of which have been registered.

More specifically, it is judged at step SE2 whether or not all the shortcut registering data has been read out from the shortcut register SCR[i]. If all the shortcut registering data has not been read out from the shortcut register SCR[i] (NO at step SE2), the operation proceeds to step SE3, where a function name is displayed, which is included in the shortcut registering data read out from the shortcut register SCR[i] corresponding to the search pointer i. At step SE4, the search pointer i is incremented and then the operation returns to step SE2. Thereafter, the processes at step SE2 through step SE4 are repeatedly executed until all the shortcut registering data has been read out from the shortcut register SCR[i], and the icon removing screen is created, which displays a list of the function names included in the read out shortcut registering data.

When all the shortcut registering data has been read out from the shortcut register SCR[i] (YES at step SE2), the operation advances to step SE5, one function name among the list of function names is highlighted. At step SE6 through step SE9 are executed processes corresponding to operation of the cursor switch, the decision switch and the clear switch. When the clear switch is operated to cancel the icon removing process (YES at step SE9), the present process is finished. Meanwhile, when the cursor switch is operated (YES at step SE6), the operation proceeds to step SE7, where another function name is highlighted. When the decision switch is operated (YES at step SE8), the operation advances to step SE10.

At step SE10, a value corresponding to the highlighted function name is stored to the search pointer i, and at the following step SE11, the shortcut registering data stored in the shortcut register SCR[i] corresponding to the above mentioned search pointer i is removed or cleared. In processes at step SE12 through step SE 15, upon clearance of the shortcut register SCR[i] at step SE11, orders are successively moved up by one to transfer the following shortcut registering data to the cleared shortcut register SCR[i]. And then the rearmost shortcut register SCR[i] is cleared and the present process is finished.

In the icon removing process described above, when the user selects a function name on the icon removing screen displaying the list of function names whose shortcuts have been registered, to remove the corresponding shortcut, the shortcut register SCR[i] storing the shortcut registering data corresponding to the selected function name is cleared. Thereafter, an order is moved up one by one to transfer the following shortcut registering data to the cleared shortcut register SCR[i], and then the rearmost shortcut register SCR[i] is cleared. And in the stand-by screen displaying process (FIG. 5), upon clearance of the shortcut register SCR[i], the shortcut icon image stored in the corresponding register DSP[i] is subjected to a non-display process, whereby the icon whose shortcut is released is removed form the stand-by screen.

(6) Operation of a shortcut registering process:

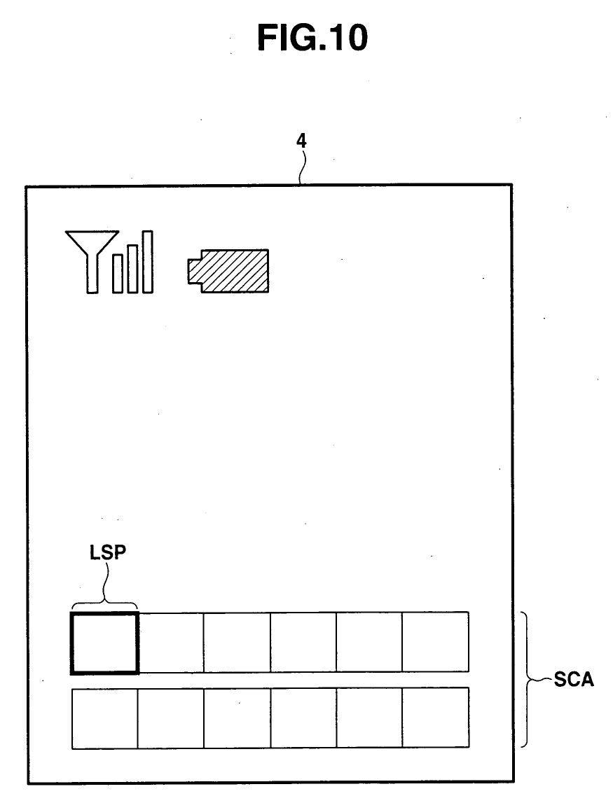

Operation of the shortcut registering process will be described with reference to the flow chart of FIG. 9. When the shortcut registering process of step SA20 in the main routine process (FIG. 3) is executed, the control section 13 advances to step SF1 shown in FIG. 9, where the search pointer is reset to “0”. In processes at step SF2 to SF3, an empty shortcut register SCR[i] is searched for, in which no shortcut registering data has been stored, while the search pointer is incremented. When an empty shortcut register SCR[i] has been found (YES at step SF2), the operation advances to step SF4.

In processes at step SF4 to SF6, while the search pointer i is decremented, the orders of the shortcut register SCR[i] are successively moved down by one to assign to the shortcut register SCR[0] a function whose shortcut is to be registered. When the search pointer i has been decremented “0” (YES at step SF6), the operation advances to step SF7, where shortcut registering data is registered in the shortcut register SCR[0], which data includes a function name of a function (previous function) designated in the processes at step SA14 to Step SA16 in the main routine process (FIG. 3) and executed at step SA19 and a program pointer designating a process program corresponding to the function name. Then, the present process is completed.

As has been described, according to the embodiment of the present invention, when the function designated by operation of the function setting switch has been executed, the shortcut icon for demanding to start up the function is automatically registered to the stand-by screen. When the user operates the shortcut icon registered to the stand-by screen, the function assigned to the shortcut icon automatically starts up whereby even if the user operates a wrong switch and starts up an undesired function, the function which has been previously executed can be called out easily and instantly.

In the embodiment of the invention, when the shortcut icon for demanding to start up the function is automatically registered at the time when a function has been executed, the shortcut icon is displayed at all times at a position easy to select and operate, for example, at a leading shortcut position LSP within a shortcut display area SCA of the stand-by screen shown in FIG. 10, where plural shortcut icons are disposed and displayed. Therefore, the user can find at a glance and call out in a simple manner the function which has been executed just before.

Further, in the embodiment of the invention, since positions of the shortcut icons previously registered on the stand-by screen are shifted one by one every time a shortcut icon for demanding to start up the function that has been executed just before is automatically registered, the shortcut icons are disposed and displayed on the stand-by screen in the order of execution of the functions. A history of execution of the functions can be represented on the stand-by screen.

In the embodiment of the invention, a shortcut for demanding to start up a function is automatically registered at the time when the function has been executed, but the embodiment may modified such that a shortcut for demanding to start up a function is automatically registered at the time when the function starts up. Even in the modified embodiment, the function that has been executed just before may be called out in a simple manner.

Further, in the embodiment set forth above, the shortcut icon for demanding to start up a function is registered to the stand-by screen when performance of such function has been finished but the screen to which the shortcut icon is registered is not limited to the stand-by screen. Such shortcut icon may be automatically registered to a screen that the user is allowed to customize such as a “my function menu screen”.

1. A function calling apparatus with a display unit for displaying a display screen, comprising:
function designating means for designating a function to be executed;
display controlling means for, when execution of the function designated by the function designating means has been completed, displaying a shortcut icon of instructing to start up the function on the display screen of the display unit; and
start-up instructing means for, when a user operates the shortcut icon displayed by the display controlling means, instructing to start up the function assigned to the shortcut icon operated by the user.

2. The function calling apparatus according to claim 1, wherein the display screen of the display unit is provided with an icon disposing and displaying area, and the display controlling means displays the shortcut icon at a leading display-position on the icon disposing and displaying area of the display screen.

3. The function calling apparatus according to claim 2, wherein the display controlling means displays shortcut icons respectively at display-positions each shifted by one in display-position on the icon disposing and displaying area of the display screen, every time a new shortcut icon is displayed at the leading display-position on the icon disposing and displaying area of the display screen.

4. The function calling apparatus according to claim 1, wherein the display screen of the display unit is a stand-by screen of a cellular phone.

5. The function calling apparatus according to claim 2, further comprising:
icon removing means for removing either of the shortcut icons displayed on the icon disposing and displaying area from an icon removing display screen other than the display screen on the display unit.

6. The function calling apparatus according to claim 2, further comprising:
icon adding means for designating on an icon adding display screen other than the display screen of the display unit either of functions whose shortcut icons are not displayed on the icon disposing and displaying area of the display screen, and for displaying the shortcut icon corresponding to the designated function on the icon disposing and displaying area of the display screen.

7. A function calling apparatus with a display unit for displaying a display screen, comprising:
function designating means for designating a function to be executed;
display controlling means for, when the function designated by the function designating means is executed, displaying a shortcut icon of instructing to start up the function on the display screen of the display unit; and
start-up instructing means for, when a user operates the shortcut icon displayed on the display screen by the display controlling means after execution of the function designated by the function designating means has been completed, instructing to start up the function assigned to the shortcut icon operated by the user.

8. The function calling apparatus according to claim 7, wherein the display screen of the display unit is provided with an icon disposing and displaying area, and the display controlling means displays the shortcut icon at a leading display-position on the icon disposing and displaying area of the display screen.

9. The function calling apparatus according to claim 8, wherein the display controlling means displays shortcut icons respectively at display-positions each shifted by one in display-position on the icon disposing and displaying area of the display screen, every time a new shortcut icon is displayed at the leading display-position on the icon disposing and displaying area of the display screen.

10. The function calling apparatus according to claim 7, wherein the display screen of the display unit is a stand-by screen of a cellular phone.

11. The function calling apparatus according to claim 8, further comprising:
icon removing means for removing either of the shortcut icons displayed on the icon disposing and displaying area from an icon removing display screen other than the display screen on the display unit.

12. The function calling apparatus according to claim 8, further comprising:
icon adding means for designating on an icon adding display screen other than the display screen of the display unit either of functions whose shortcut icons are not displayed on the icon disposing and displaying area of the display screen, and for displaying the shortcut icon corresponding to the designated function on the icon disposing and displaying area of the display screen.

13. A function calling apparatus with a display unit for displaying a display screen, comprising:
function designating means for designating a function to be executed;
display controlling means for, when execution of the function designated by the function designating means has been completed, displaying a shortcut icon of instructing to start up the function at all times at a position easy to select first on the display screen of the display unit; and
start-up instructing means for, when a user operates the shortcut icon displayed by the display controlling means, instructing to start up the function assigned to the shortcut icon operated by the user.

14. The function calling apparatus according to claim 13, wherein the display screen of the display unit is provided with an icon disposing and displaying area, and the display controlling means displays the shortcut icon at a leading display-position on the icon disposing and displaying area of the display screen.

15. The function calling apparatus according to claim 14, wherein the display controlling means displays shortcut icons respectively at display-positions each shifted by one in display-position on the icon disposing and displaying area of the display screen, every time the display controlling means displays a new shortcut icon at the position easy to select first on the display screen.

16. The function calling apparatus according to claim 13, wherein the display screen of the display unit is a stand-by screen of a cellular phone.

17. The function calling apparatus according to claim 14, further comprising:
icon removing means for removing either of the shortcut icons displayed on the icon disposing and displaying area from an icon removing display screen other than the display screen on the display unit.

18. The function calling apparatus according to claim 14, further comprising:
icon adding means for designating on an icon adding display screen other than the display screen of the display unit either of functions whose shortcut icons are not displayed on the icon disposing and displaying area of the display screen, and for displaying the shortcut icon corresponding to the designated function on the icon disposing and displaying area of the display screen.

19. A computer program for executing a function calling process comprising:
a function designating process for designating a function to be executed;
a display controlling process for, when execution of the function designated in the function designating process has been completed, displaying a shortcut icon of instructing to start up the function on a display screen; and
a start-up instructing process for, when a user operates the shortcut icon displayed on the display screen in the display controlling process, instructing to start up the function assigned to the shortcut icon operated by the user.

20. A computer program for executing a function calling process comprising:
a function designating process for designating a function to be executed;
a display controlling process for, when the function designated in the function designating process is executed, displaying a shortcut icon of instructing to start up the function on a display screen; and
a start-up instructing process for, when a user operates the shortcut icon displayed in the display controlling process after execution of the function designated in the function designating process has been completed, instructing to start up the function assigned to the shortcut icon operated by the user.

21. A computer program for executing a function calling process comprising:
a function designating process for designating a function to be executed;
a display controlling process for, when execution of the function designated in the function designating process has been completed, displaying a shortcut icon of instructing to start up the function at all times at a position easy to select first on a display screen; and
a start-up instructing process for, when a user operates the shortcut icon displayed in the display controlling process, instructing to start up the function assigned to the shortcut icon operated by the user.
